(19) United States
(12) Patent Application Publication
(10) Pub. No.: US 2025/0385504 A1
(43) Pub. Date: Dec. 18, 2025

(54) CONDUCTOR SPLICE CONNECTORS FOR USE WITH HYBRID CONDUCTORS

(71) Applicant: AFL Telecommunications LLC, Duncan, SC (US)

(72) Inventors: Steven E. Kranz, Moore, SC (US); Matthew G. Welborn, Greenville, SC (US)

(21) Appl. No.: 19/232,417

(22) Filed: Jun. 9, 2025

Related U.S. Application Data
(60) Provisional application No. 63/659,430, filed on Jun. 13, 2024.

(51) Int. Cl. H02G 15/10; G02B 6/255

(52) U.S. Cl. CPC H02G 15/10; G02B 6/2558

(57) ABSTRACT

A conductor splice connector includes an outer body defining an outer body interior. The conductor splice connector further includes a core grip, the core grip defining a core grip interior and further defining a window in communication with the core grip interior. The core grip is housed within the outer body interior. An alternative conductor splice connector includes an outer body defining an outer body interior. The conductor splice connector further includes a first collet assembly, a second collet assembly, and a transition connector, wherein the transition connector connects the first collet assembly and second collet assembly.

### CROSS-REFERENCE TO RELATED APPLICATIONS

The present application claims priority to U.S. Provisional Patent Application Ser. No. 63/659,430 filed on Jun. 13, 2024, the disclosure of which is incorporated by reference herein in its entirety.

### FIELD

The present disclosure relates generally to conductor splice connectors and assemblies, and more particularly to conductor splice connectors and assemblies that facilitate the use of hybrid conductors.

### BACKGROUND

Conductors are utilized in a variety of environments for carrying electrical current and generally facilitating the transmission of electricity. Conductor splice connectors are utilized to connect the conductors to other conductors, such as in a mid-span splice configuration. In many cases, the conductors are installed in relatively high tension. Due to the relatively high-tension environments, it is desirable for the splice connection to be robust, thereby preventing relative movement between the conductors and/or disconnection of the conductors from each other. It is generally desirable in the industry for a conductor splice connector to properly function at no less than 95% of the associated conductor's rated breaking strength.

In a typical known conductor, the “core” is the physical strength member of the conductor, and outer aluminum stranding provides the path of electrical current flow. Conductor technology available to electrical utilities is rapidly improving. For example, conductor manufacturers are developing ways of monitoring aerial electrical systems by means of optical fiber sensing constructed within the conductor. As these sensing units require continuous stranding for a complete information path to be communicated, the sensing units must not be discontinued within a conductor splice connector used to hold the conductor under a high load value of tension at a transmission or distribution tower structure. As such, a device to grip such conductor while providing both a continuous electrical and continuous optical path is required.

One problem with existing technology is that, in addition to splicing together the conductors using known conductor splice connectors, the optical fibers of the spliced conductors must be spliced together to provide a continuous sensing unit path. This spliced path must be protected within the conductor splice connector.

Accordingly, improved conductor splice connectors and assemblies, in particular for use with hybrid conductors, are desired in the art. In particular, improved conductor splice connectors and assemblies which address one or more of the above-described known deficiencies would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a conductor splice connector is provided. The conductor splice connector includes an outer body defining an outer body interior. The conductor splice connector further includes a core grip, the core grip defining a core grip interior and further defining a window in communication with the core grip interior. The core grip is housed within the outer body interior.

In accordance with another embodiment, a conductor splice connector is provided. The conductor splice connector includes an outer body defining an outer body interior. The conductor splice connector further includes a first collet assembly, the first collet assembly comprising a collet and a collet housing, and a second collet assembly, the second collect assembly comprising a collet and a collet housing. The conductor splice connector further includes a transition connector, wherein the transition connector connects the first collet assembly and second collet assembly. The first collet assembly, the second collet assembly, and the transition connector are housed within the outer body interior.

In accordance with another embodiment, a conductor splice connector is provided. The conductor splice connector includes an outer body defining an outer body interior. The conductor splice connector further includes means for conductor splicing and optical fiber splicing housed within the outer body interior.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a conductor splice assembly in accordance with embodiments of the present disclosure;

FIG. 2 is a side cross-sectional view of a conductor splice assembly in accordance with embodiments of the present disclosure;

FIG. 3 is a side view of components of a conductor splice assembly during assembly thereof in accordance with embodiments of the present disclosure;

FIG. 4 is a perspective view of a conductor splice assembly, with the outer body removed for illustrative purposes, in accordance with embodiments of the present disclosure;

FIG. 5 is a perspective view of components of a conductor splice assembly, illustrating optical component routing therein, in accordance with embodiments of the present disclosure;

FIG. 6 is an opposite perspective view of components of a conductor splice assembly, illustrating alternative optical component routing therein, in accordance with embodiments of the present disclosure;

FIG. 7 is a perspective view of a conductor splice assembly, with the outer body removed for illustrative purposes, in accordance with embodiments of the present disclosure;

FIG. 8 is a perspective view of a conductor splice assembly, with the outer body and collet housings removed for illustrative purposes, in accordance with embodiments of the present disclosure;

FIG. 9 is a perspective view of a collet housing of a conductor splice connector in accordance with embodiments of the present disclosure;

FIG. 10 is a perspective view of a conductor splice assembly, with the outer body and collet assemblies removed for illustrative purposes, in accordance with embodiments of the present disclosure; and

FIG. 11 is a perspective view illustrating various layers of conductors, including a splice section formed between optical components of the conductors, in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The present disclosure relates generally to improved conductor splice connectors and assemblies. In exemplary embodiments, such conductor splice connectors may be utilized with, and such conductor assemblies may include, hybrid conductors. Such conductor splice connectors and assemblies may advantageously facilitate secure connections of the associated conductors in high tension environments while also allowing continuous conductor paths, such as continuous electrical and continuous optical paths. In exemplary embodiments, such conductor splice connectors properly function at no less than 95% of the associated conductor's rated breaking strength.

Conductor splice connectors in accordance with the present disclosure may be utilized with, and conductor assemblies may include, conductors. In exemplary embodiments, a conductor in accordance with the present disclosure may be a hybrid conductor which includes both electrical and optical components. Alternatively, however, such conductor may include only electrical components.

Referring now to FIG. 11, one embodiment of conductors 200, 200′ with which a conductor splice connector 10 may be utilized is provided. In exemplary embodiments, conductors 200, 200′ with which conductor splice connectors 10 are utilized may be “jacketed” (or “covered”) conductors. In alternative embodiments, conductors 200, 200′ with which conductor splice connectors 10 are utilized may be non-jacketed or uncovered conductors. In exemplary embodiments, conductor splice connectors 10 in accordance with the present disclosure may be utilized with aluminum conductor composite reinforced (“ACCR”) conductors, aluminum conductor composite core (“ACCC”), aluminum conductor steel supported (“ACSS”) conductors, aluminum conductor composite supported (“ACCS”) conductors, aluminum conductor steel reinforced (“ACSR”) conductors, alumoweld (“AW”) conductors, all aluminum conductors (“AAC”), steel ground wire, or other suitable conductors. Conductors having single member cores, or multiple member cores (such as stranded cores) may be utilized. The core materials and outer layer materials may be the same or may be different.

As shown, in some embodiments, conductor 200, 200′ may include a plurality of conductor strands 202, 202′ which may be arranged as a central core 204, 204′ (which may include one, as shown, or more conductor strands 202, 202′) surrounded by one or more generally concentric layers of conductor strands, such as a first layer 206, 206′ and a second layer 208, 208′, each of which may include a plurality of conductor strands 202, 202′. The one or more layers 206, 208, 206′, 208′ may in some embodiments have a helical arrangement, with each strand 202, 202′ extending helically about a longitudinal axis of the conductor 200, 200′.

In exemplary embodiments, the conductor strands 202, 202′ of conductor 200, 200′ are formed from one or more metals. For example, in some embodiments, each conductor strand 202, 202′ is formed from steel and/or aluminum. The conductor strand(s) 202, 202′ of the core 204, 204′ may be formed from the same material as the strand(s) 206, 208, 206′, 208′ of the outer layer(s), or may be formed from a different material from the strand(s) 206, 208, 206′, 208′ of the outer layer(s). For example, the strand(s) 202, 202′ of the core 204, 204′ and/or the strand(s) of the outer layer(s) 206, 208, 206′, 208′ may be formed from steel, aluminum, aluminum fiber, aluminum reinforced with alumina fibers, carbon or glass fibers in a polymer matrix (such as an epoxy or a thermoplastic), or other suitable material(s).

In some embodiments, conductor 200, 200′ may further include one or more layers surrounding the conductor layers 206, 208, 206′, 208′. Such layers may, for example, be formed of non-conductive materials such as polymers. For example, in some embodiments, a polymer shield layer 210, 210′ may be provided on the outermost layer 208, 208′ of the conductor layers. Further, one or more jackets (such as two, three, four, or more jackets), such as an inner jacket 212, 212′ and an outer jacket 214, 214′, may be provided. Jackets 212, 214, 212′, 214′ may be formed from or include suitable polymers. For example, jackets 212, 214, 212′, 214′ may be formed from or include polyethylene, such as high density and/or crosslinked polyethylene, or another suitable thermoplastic.

In some exemplary embodiments, a conductor 200, 202′ may further include an optical component 220, 220′, which may be or include one or more optical fibers. The optical component 220, 220′ may, for example, extend through the core 204, 204′, such as through one or more strands 202, 202′ of the core 204, 204′.

In exemplary embodiments as discussed herein, an exposed section 230, 230′ of the conductor 200, 200′ may be defined. Such exposed section 230, 230′ may include only a portion of the core 204, 204′ of the conductor 200, 200′, with outer layers 206, 208, 210, 212, and/or 214, and/or 206′, 208′, 210′, 212′, and/or 214′, of the conductor 200, 200′ having been cut away and not included in the exposed section 230, 230′. Exposed sections 230, 230′ may further include exposed optical components 220, 220′ extending from the cores 204, 204′. Further, the optical components 220, 220′ of conductors 200, 200′, such as portions thereof that are in exposed sections 230, 230′, may be spliced together to form a splice section 240. Any suitable optical component splicing technique, such as fusion splicing, etc., may be utilized. Formation of the splice section 240 may provide a continuous optical path through the conductors 200, 200′. The conductors 200, 200′ may then be spliced together using a conductor splice connector to form a continuous electrical path as discussed herein.

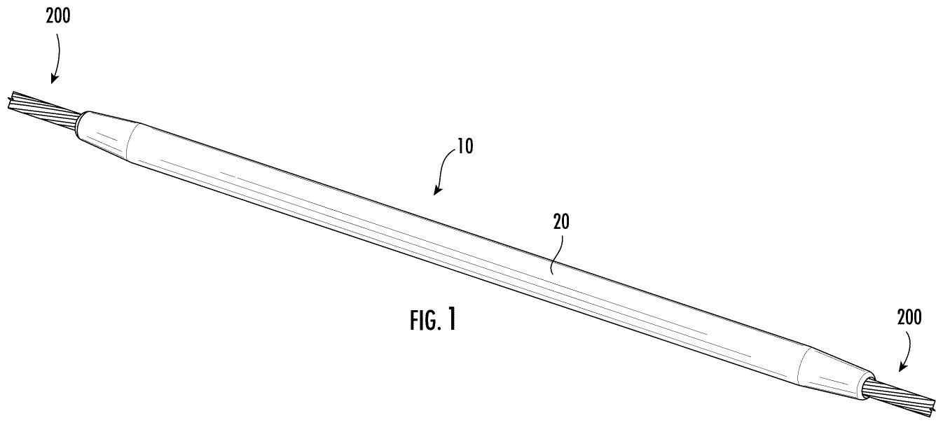

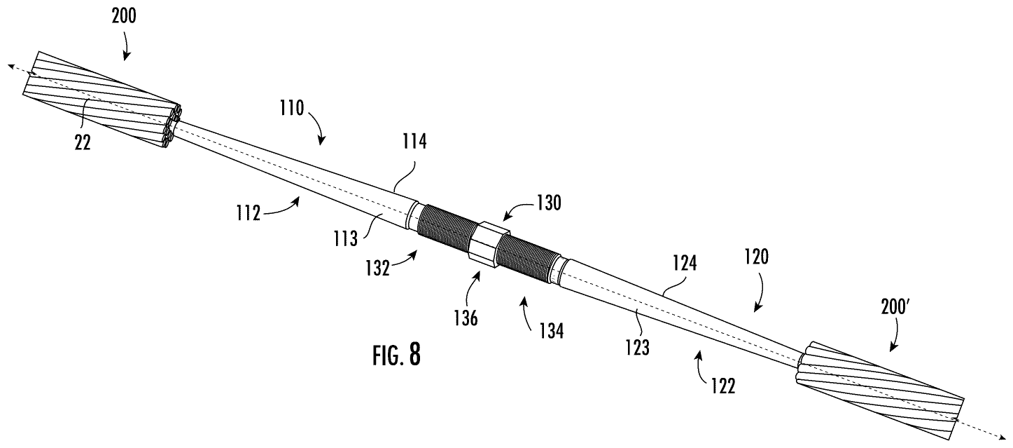

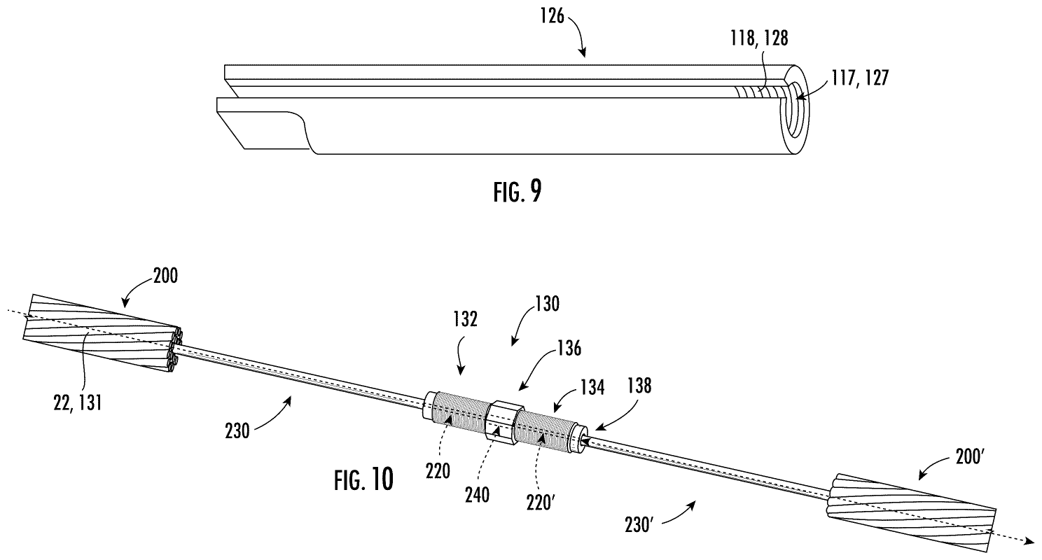

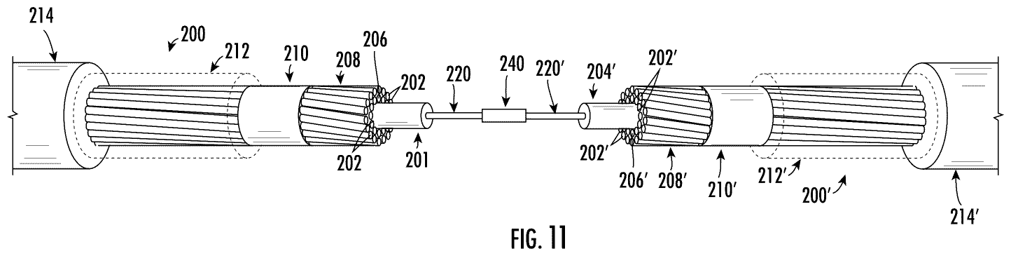

Referring now to FIGS. 1 through 10, embodiments of conductor splice connectors 10 and conductor splice assemblies which include such connectors 10 are provided. A conductor assembly in accordance with the present disclosure generally includes a conductor splice connector 10 and conductors 200, 200′ disposed in the conductor splice connector 10.

As shown in FIGS. 1 through 10, a conductor splice connector 10 may include an outer body 20. The outer body 20 may define an outer body interior 22. Interior 22 may extend through the body 20 along a longitudinal axis 24 of the body 20, and may define opposing open ends of the body 20.

In exemplary embodiments, outer bodies 20 may have a generally circular or oval cross-sectional profile.

Outer bodies 20 may be formed from a metal, such as in exemplary embodiments aluminum.

In exemplary embodiments as shown, outer body 20 may be formed as a singular, monolithic structure. Alternatively, outer body 20 may include multiple components, such as for example a base and a keeper. The base and keeper may each extend along the longitudinal axis 24 of the body 20, such as along the full length of the body 20. Thus, when the keeper is removed from the base, a slot providing access to the interior 22 may be defined in the base and may extend between and to the first and second open ends of the base. Base and keeper may together define a cross-sectional perimeter of the body 20, with the base generally defining more of the perimeter than the keeper. Base and keeper may further define the interior 22 therebetween.

Referring now generally to FIGS. 1 through 6, a conductor splice connector 10 in accordance with the present disclosure may further include a core grip 30. Core grip 30 may generally house the exposed sections 230, 230′ of conductors 200, 200′, as well as the splice section 240, provided therein. Core grip 30 may be housed in the outer body interior 22, as shown.

Core grip 30 may define a core grip interior 32. Interior 32 may extend through the core grip 30 along a longitudinal axis 34 of the core grip 30 (which may be parallel and/or coaxial with longitudinal axis 24), and may define opposing open ends of the core grip 30.

In exemplary embodiments, core grip 30 may have a generally circular or oval cross-sectional profile.

Core grip 30 may be formed from a metal, such as in exemplary embodiments a steel.

Core grip 30 may further define a window 36. The window 36 may be a cutout portion of the core grip 30 which is in communication with and thus provides access from the exterior of the core grip 30 through the core grip 30 to the interior 32. Window 36 may be located between the opposing open ends of the core grip 30, such as generally centrally along a length of the core grip 30 (e.g. along the longitudinal axis 34).

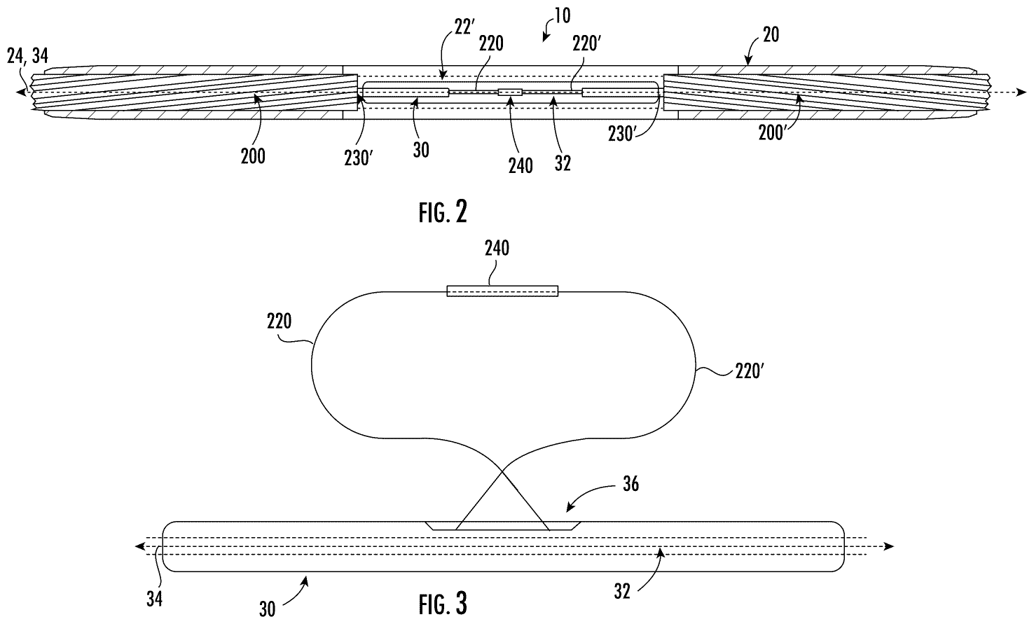

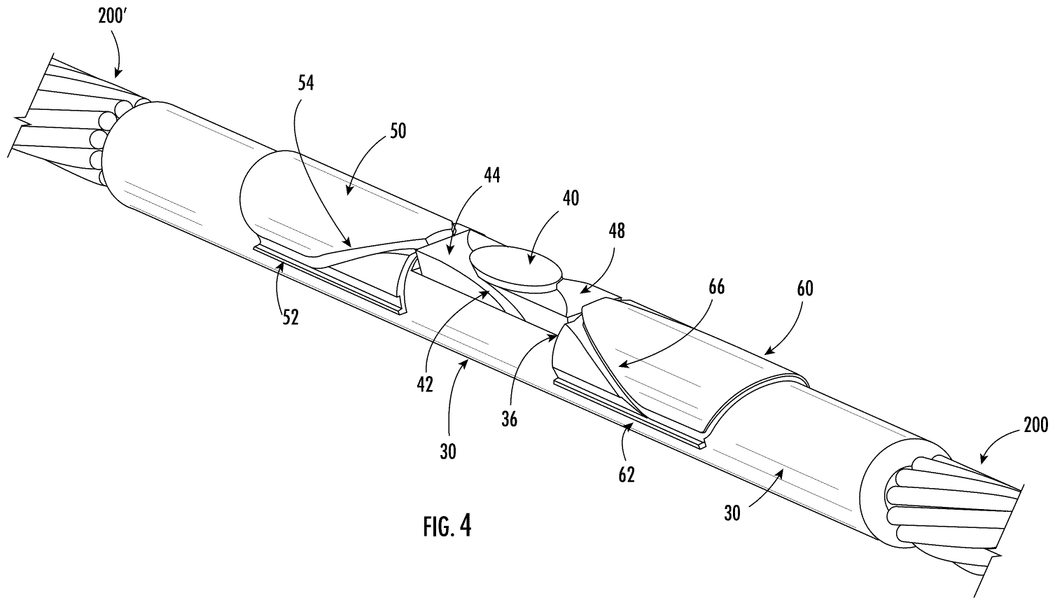

As shown in FIG. 2, in some embodiments, the exposed sections 230, 230′ and splice section 240 may be housed in the core grip 30. For example, as shown in FIG. 3, during assembly exposed sections 230, 230′ may be provided into the core grip interior 32 through the opposing open ends of the core grip 30. The exposed sections 230, 230′ may further be provided through the window 36 such that they are exposed exterior to the core grip 30 for splicing. The optical components 220, 220′ may be spliced together to form splice section 240, and the exposed sections 230, 230′ and splice section 240 may then be reinserted through window 36 into interior 32 (as shown in FIG. 2).

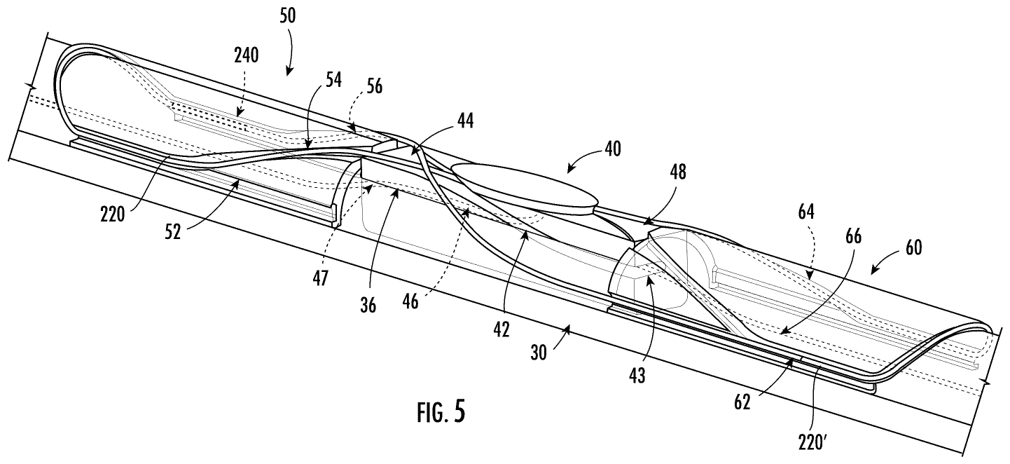

Referring now to FIGS. 4 through 6, in some embodiments, additional components may be provided along with core grip 30 in the interior 22 to provide further routing and protection of the optical components 220, 220′ and spice section 240. For example, conductor splice connector 10 may further include a transition block 40. The transition block 40 may be provided in the connector 10 to facilitate a transition of the optical components 220, 220′ from the core grip interior 32 to exterior to the core grip interior 32 for routing and splicing purposes. Accordingly, when assembled as shown, transition block 40 may be inserted through window 36, such that a portion of the transition block 40 is disposed within the core grip interior 32 and a portion of the transition block 40 is disposed exterior to the core grip interior 32.

As shown, transition block 40 may include a first outer channel 42 and a second outer channel 46. The channels may be open channels defined in the sides of the transition block 40 or closed channels defined through the transition block.

First outer channel 42 may extend between a first end 43 and a second end 44, both of which may be open such that optical components 220, 220′ can enter and exit the channel 42 therethrough. When assembled, the first end 43 may be disposed within the core grip interior 32 and the second end 44 may be disposed exterior to the core grip interior 32. In some embodiments, as illustrated, the second end 44 may be flared, such that an optical component 220, 220′ extending therefrom may be routed in multiple different directions without any bending or attenuation concerns.

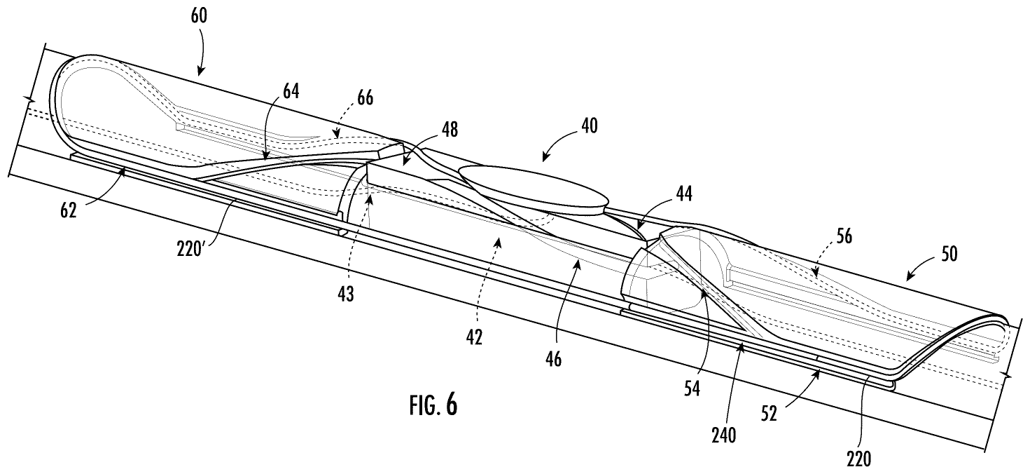

Second outer channel 46 may extend between a first end 47 and a second end 48, both of which may be open such that optical components 220, 220′ can enter and exit the channel 46 therethrough. When assembled, the first end 47 may be disposed within the core grip interior 32 and the second end 48 may be disposed exterior to the core grip interior 32. In some embodiments, as illustrated in FIG. 6, the second end 46 may be flared, such that an optical component 220, 220′ extending therefrom may be routed in multiple different directions without any bending or attenuation concerns.

In exemplary embodiments as shown, the first and second outer channels 42, 46 may be disposed on opposing sides of the transition block 40, such as relative to the longitudinal axis 34, such as when viewed from above. In exemplary embodiments, the first and second outer channels 42, 46 do not cross.

In some embodiments, the transition block 40 may be formed from a plastic. Alternatively, the transition block 40 may be formed from a metal.

Connector 10 may further include a first routing clamp 50 and a second routing clamp 60. The first and second routing clamps 50, 60, may facilitate routing of the optical components 220, 220′ and positioning of the optical components 220, 220′ and splice section 240 such that the optical components 220, 220′ and splice section 240 are protected after splicing and routing. First and second routing clamps 50, 60 may be disposed exterior to the core grip interior 32, such as on the core grip 30, e.g. on an exterior surface thereof. First and second routing clamps 50, 60 may in exemplary embodiments have generally arcuate cross-sectional profiles. In exemplary embodiments, the routing clamps 50, 60, may be removably mountable onto the core grip 30, as shown.

In exemplary embodiments, the transition block 40 may be positioned between the first routing clamp 50 and the second routing clamp 60, such as along the longitudinal axis 34. In exemplary embodiments, the window 36 may be positioned between the first routing clamp 50 and the second routing clamp 60, such as along the longitudinal axis 34.

First routing clamp 50 may include a perimeter channel 52 defined in the clamp, such as in an exterior surface thereof. The channel 52 may be an open channel as shown, and may extend around at least a portion of a perimeter of the clamp 50, as shown. For example, the channel 52 may extend through sides edges of the clamp 50 and an end edge of the clamp 50 that is distal to the transition block 40. In some embodiments, the channel 52 may not extend through an end edge of the clamp 50 that is proximate to the transition block 40.

The first routing clamp 50 may further include one or more transition channels, such as a first transition channel 54 and/or a second transition channel 56, defined in the clamp 50, such as in an exterior surface thereof. The channel(s) 54, 56 may be open channels as shown. Each transition channel 54, 56 may be in communication with the perimeter channel 52. For example, a first end of the transition channel 54, 56 may be disposed an end edge of the clamp 50 that is proximate to the transition block 40, and a second end of the transition channel 54, 56 may be defined in the perimeter channel 52 such that the transition channel 54, 56 transitions directly into the perimeter channel 52 at the second end thereof.

In exemplary embodiments as shown, the transition channels 54, 56 may be disposed on opposing sides of the transition block 40, such as relative to the longitudinal axis 34, such as when viewed from above. In exemplary embodiments, the first and second transition channels 54, 56 do not cross. First transition channel 54 may transition into the perimeter channel 52 at one side edge thereof, and second transition channel 56 may transition into the perimeter channel 52 at the other, opposite side edge thereof.

The second routing clamp 60 may in exemplary embodiments be a mirrored image of the first routing clamp 50 (such as relative to a plane perpendicular to the longitudinal axis 34). Second routing clamp 60 may include a perimeter channel 62 defined in the clamp, such as in an exterior surface thereof. The channel 62 may be an open channel as shown, and may extend around at least a portion of a perimeter of the clamp 60, as shown. For example, the channel 62 may extend through sides edges of the clamp 60 and an end edge of the clamp 60 that is distal to the transition block 40. In some embodiments, the channel 62 may not extend through an end edge of the clamp 60 that is proximate to the transition block 40.

The second routing clamp 60 may further include one or more transition channels, such as a first transition channel 64 and/or a second transition channel 66, defined in the clamp 60, such as in an exterior surface thereof. The channel(s) 64, 66 may be open channels as shown. Each transition channel 64, 66 may be in communication with the perimeter channel 62. For example, a first end of the transition channel 64, 66 may be disposed an end edge of the clamp 60 that is proximate to the transition block 40, and a second end of the transition channel 64, 66 may be defined in the perimeter channel 62 such that the transition channel 64, 66 transitions directly into the perimeter channel 62 at the second end thereof.

In exemplary embodiments as shown, the transition channels 64, 66 may be disposed on opposing sides of the transition block 40, such as relative to the longitudinal axis 34, such as when viewed from above. In exemplary embodiments, the first and second transition channels 64, 66 do not cross. First transition channel 64 may transition into the perimeter channel 62 at one side edge thereof, and second transition channel 66 may transition into the perimeter channel 62 at the other, opposite side edge thereof.

In some embodiments, the first and second routing clamps 50, 60 may each be formed from a plastic. Alternatively, the first and second routing clamps 50, 60 may each be formed from a metal.

FIGS. 5 and 6 illustrate routing of optical components 220, 220′ and splice section 240′ in and through transition block 40 and first and second routing clamps 50, 60 in accordance with embodiments of the present disclosure.

For example, as illustrated in FIG. 5, a first optical component 220 may enter transition block 40 from core grip interior 32 through the first end 43 of the first outer channel 42, and may exit the first outer channel 42 through the second end 44 thereof. The optical component 220 may further be routed from the second end 44 to the first routing clamp 50, such as to the first transition channel 54 through the first end thereof and from the first transition channel 54 to the perimeter channel 52. The optical component 220 may further transition to the splice section 240, which may be routed through the perimeter channel 52, such as through a side edge portion of the perimeter channel 52 as shown. The second optical component 220′ may enter transition block from core grip interior 32 through the first end 47 of the second outer channel 46, and may exit the second outer channel 46 through the second end 48 thereof. The optical component 220′ may further be routed from the second end 48 to the second routing clamp 60, such as to the first transition channel 64 through the first end thereof and from the first transition channel 64 to the perimeter channel 62. The optical component 220′ may further exit the perimeter channel 62 (either directly or via the second transition channel 66) and be routed across the transition block 40 to the perimeter channel 52 (either directly or via the second transition channel 56). The optical component 220′ may further transition to the splice section 240, as shown.

Alternatively, as illustrated in FIG. 6, a first optical component 220 may enter transition block 40 from core grip interior 32 through the first end 43 of the first outer channel 42, and may exit the first outer channel 42 through the second end 44 thereof. The optical component 220 may further be routed from the second end 44 to the first routing clamp 50, such as to the first transition channel 54 through the first end thereof and from the first transition channel 54 to the perimeter channel 52. The optical component 220 may further transition to the splice section 240, which may be routed through the perimeter channel 52, such as through a side edge portion of the perimeter channel 52 as shown. The second optical component 220′ may enter transition block from core grip interior 32 through the first end 47 of the second outer channel 46, and may exit the second outer channel 46 through the second end 48 thereof. The optical component 220′ may further be routed from the second end 48 to the second routing clamp 60, such as to the second transition channel 66 through the first end thereof and from the second transition channel 66 to the perimeter channel 62. The optical component 220′ may further directly exit the perimeter channel 62 and be routed past the transition block 40 directly to the perimeter channel 52. The optical component 220′ may further transition to the splice section 240, as shown.

It should be understood that the above-described embodiments illustrate various options for routing optical components 220, 220′ and splice section 240, but the present disclosure is not so limited to such embodiments. Rather, the design of the first and second routing clamps 50, 60 and the transition block 40 advantageously provide options and flexibility for routing optical components 220, 220′ and splice section 240 while also protecting such components and maintaining a continuous optical path.

When assembled, the various components discussed herein, such as the core grip 30, transition block 40, and first and second routing clamps 50, 60, may be disposed in the outer body interior 22.

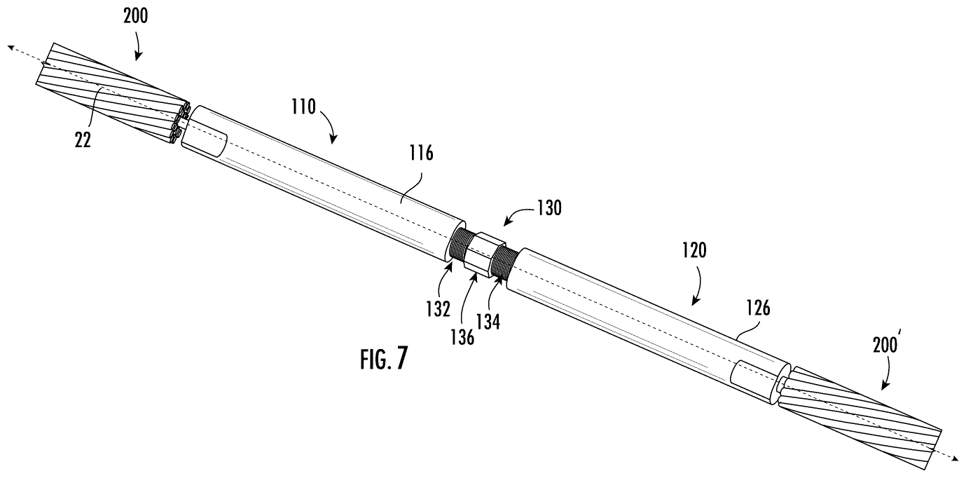

Referring now to FIGS. 7 through 10, alternative embodiments of conductor splice connectors 10 are provided. Such splice connectors 10 may include an outer body 20. Further, such conductor splice connectors 10 may include a first collet assembly 110, a second collet assembly 120, and a transition connector 130. The first collet assembly 110, second collet assembly 120, and transition connector 130 may together generally house the exposed sections 230, 230′ of conductors 200, 200′, as well as the splice section 240, provided therein. When assembled, the first collet assembly 110, second collet assembly 120, and transition connector 130 may be housed in the outer body interior 22, as shown.

First collet assembly 110 may include a collet 112 and a collet housing 116. Collet 112 may be generally wedge-shaped and may include first and second portions or halves 113, 114. The collet 112, such as the portions 113, 114 thereof, may be provided around a portion of the exposed section 230 of the conductor 200. The collet 112 may then be inserted into the collet housing 116, which includes a generally wedge-shaped interior 117 defined therein. During operation, tensile forces in the conductor 200 may be transmitted through the collet 112 to the collet housing 116 due, for example, to the wedge-shaped collet 112 and interior 117. Such transmission may in turn increase the connection forces between the collet 112 and housing 116, and thus between the conductor 200 and collet assembly 110 generally.

Second collet assembly 120 may include a collet 122 and a collet housing 126. Collet 122 may be generally wedge-shaped and may include first and second portions or halves 123, 124. The collet 122, such as the portions 123, 124 thereof, may be provided around a portion of the exposed section 230′ of the conductor 200′. The collet 122 may then be inserted into the collet housing 126, which includes a generally wedge-shaped interior 127 defined therein. During operation, tensile forces in the conductor 200′ may be transmitted through the collet 122 to the collet housing 126 due, for example, to the wedge-shaped collet 122 and interior 127. Such transmission may in turn increase the connection forces between the collet 122 and housing 126, and thus between the conductor 200′ and collet assembly 120 generally.

Transition connector 130 may be disposed between the collet assemblies 110, 120, such as along the longitudinal axis 34. Transition connector 130 may connect the collet assemblies 110, 120 together, as shown. For example, transition connector 130 may include a first mating threaded portion 132 and a second mating threaded portion 134. First mating threaded portion 132 may be threadably connectable to a threaded portion of the first collet assembly 110, such as a threaded portion 118 of collet housing 116. Second mating threaded portion 134 may be threadably connectable to a threaded portion of the second collet assembly 120, such as a threaded portion 128 of collet housing 126.

In exemplary embodiments, transition connector 130 may include a central portion, which may for example be in the form of a nut 136. Nut 136 may be disposed between the first and second threaded portions 132, 134, such as along the longitudinal axis 24. The central portion may provide a transition between the threaded portions 132, 134, and in the form of a nut 136 may facilitate treadable connection of the threaded portions 132, 134 to the threaded portions 118, 128.

In exemplary embodiments, transition connector 130 may define a transition connector interior 138. Interior 138 may extend through the transition connector 130 along a longitudinal axis 131 of the transition connector 130 (which may be parallel and/or coaxial with longitudinal axis 24), and may define opposing open ends of the transition connector 130.

In exemplary embodiments, wherein the first collet assembly 110, the second collet assembly 120, and the transition connector 130 are each formed from a metal, such as in exemplary embodiments a steel.

The first collet assembly 110, the second collet assembly 120, and the transition connector 130, may advantageously facilitate routing and protection of the exposed sections 230, 230′, including the optical components 220, 220′ and splice section 240. For example, portions of the exposed sections 230, 230′ may extend into and through collet assemblies 110, 120, and the collet assemblies 110, 120 may secure the exposed sections 230, 230′. Transition connector 130 may further secure the collet assemblies 110, 120 together, and may accommodate the optical components 220, optical component 220′, and/or splice section 240 in the interior 138 thereof, thus protecting the optical components 220′ and maintaining a continuous optical path.

Referring again to FIG. 1, outer body 20 may serve to house and protect within the interior 22 thereof portions of the exposed sections 230, 230′, splice section 240, and core grip 30, transition block 40, routing clamps 50, 60, and/or first collet assembly 110, second collet assembly 120, and transition connector 130. Thus, a continuous optical path is maintained. Further, portions of conductors 200, 200′ may be housed in the outer body 20, such as within the interior 22 thereof. Thus, a continuous electrical path is maintained.

The present disclosure further provides methods for connecting conductors 200, 200′ to conductor splice connectors 10 to form conductor splice assemblies. A method in accordance with the present disclosure may include, for example, removing one or more layers 206, 208, 210, 212, and/or 214 from a conductor 200 to reveal an exposed section 230 of the conductor 200, as discussed herein. A method in accordance with the present disclosure may include, for example, removing one or more layers 206′, 208′, 210′, 212′, and/or 214′ from a conductor 200′ to reveal an exposed section 230′ of the conductor 200′, as discussed herein.

In some embodiments, the method may further include, for example, inserting the exposed sections 230, 230′ into a core grip 30, as discussed herein.

In some embodiments, the method may further include routing optical components 220, 220′, and/or splice section 240 through a transition block 40 and/or routing clamps 50, 60, as discussed herein.

In some embodiments, the method may further include forming a splice section 240 as discussed herein.

In some embodiments, the method may further include compressing the core grip 30. Such compressing step may occur after the exposed sections 230, 230′ are inserted into the interior 32. In some embodiments, such compression may occur at compression portions between which is disposed the window 36.

In some embodiments, the method may further include routing optical components 220, 220′, and/or splice section 240 through a first collet assembly 110, second collet assembly 120, and transition connector 130, as discussed herein.

In some embodiments, the method may further include inserting the exposed sections, 230, 230′, splice section 240, and core grip 30, transition block 40, routing clamps 50, 60, and/or first collet assembly 110, second collet assembly 120, and transition connector 130 into an outer body 20. In some embodiments, the method may further include inserting portions of conductors 200, 200′ into the outer body 20, such as within the interior 22 thereof.

Thus, continuous optical and electrical paths are provided.

Further aspects of the invention are provided by one or more of the following embodiments:

A conductor splice connector which includes an outer body defining an outer body interior. The conductor splice connector further includes a core grip, the core grip defining a core grip interior and further defining a window in communication with the core grip interior. The core grip is housed within the outer body interior.

A conductor splice connector in accordance with one or more embodiments shown or described herein, further including a transition block inserted through the window, the transition block comprising a first outer channel and a second outer channel.

A conductor splice connector in accordance with one or more embodiments shown or described herein, wherein the first and second outer channels are disposed on opposing sides of the transition block.

A conductor splice connector in accordance with one or more embodiments shown or described herein, wherein the first and second outer channels each extend between a first end disposed within the core grip interior and a second end disposed exterior to the core grip interior.

A conductor splice connector in accordance with one or more embodiments shown or described herein, further comprising a first routing clamp and a second routing clamp, each of the first and second routing clamps disposed on the core grip such that the window is positioned between the first and second routing clamps.

A conductor splice connector in accordance with one or more embodiments shown or described herein, wherein each of the first and second routing clamps comprises a perimeter channel defined in an exterior surface of each of the first and second routing clamps.

A conductor splice connector in accordance with one or more embodiments shown or described herein, wherein each of the first and second routing clamps further comprises a transition channel defined in the exterior surface of the first and second routing clamps, the transition channel in communication with the perimeter channel.

A conductor splice connector in accordance with one or more embodiments shown or described herein, wherein the outer body is formed from aluminum.

A conductor splice connector in accordance with one or more embodiments shown or described herein, wherein the core grip is formed from a steel.

A conductor splice connector which includes an outer body defining an outer body interior. The conductor splice connector further includes a first collet assembly, the first collet assembly comprising a collet and a collet housing, and a second collet assembly, the second collect assembly comprising a collet and a collet housing. The conductor splice connector further includes a transition connector, wherein the transition connector connects the first collet assembly and second collet assembly. The first collet assembly, the second collet assembly, and the transition connector are housed within the outer body interior.

A conductor splice connector in accordance with one or more embodiments shown or described herein, wherein the collet housings of the first and second collet assemblies each include a threaded portion.

A conductor splice connector in accordance with one or more embodiments shown or described herein, wherein the transition connector includes a first mating threading portion threadably connectable to the threaded portion of the first collect assembly, and wherein the transition connector includes a second mating threading portion threadably connectable to the threaded portion of the second collect assembly.

A conductor splice connector in accordance with one or more embodiments shown or described herein, wherein the transition connector defines a transition connector interior.

A conductor splice connector in accordance with one or more embodiments shown or described herein, wherein the transition connector comprises a nut.

A conductor splice connector in accordance with one or more embodiments shown or described herein, wherein the outer body is formed from aluminum.

A conductor splice connector in accordance with one or more embodiments shown or described herein, wherein the first collet assembly, the second collet assembly, and the transition connector are each formed from a steel.

A conductor splice connector which includes an outer body defining an outer body interior. The conductor splice connector further includes means for conductor splicing and optical fiber splicing housed within the outer body interior.

A conductor splice connector in accordance with one or more embodiments shown or described herein, wherein the outer body is formed from aluminum.

A conductor splice connector in accordance with one or more embodiments shown or described herein, wherein the means for conductor splicing and optical fiber splicing comprises a core grip.

A conductor splice connector in accordance with one or more embodiments shown or described herein, wherein the means for conductor splicing and optical fiber splicing includes a transition block, a first routing clamp, and a second routing clamp.

A conductor splice connector in accordance with one or more embodiments shown or described herein, wherein the means for conductor splicing and optical fiber splicing comprises first and second collect assemblies.

A method for conductor splicing and optical fiber splicing in accordance with one or more embodiments shown or described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A conductor splice connector, comprising:
an outer body defining an outer body interior;
a core grip, the core grip defining a core grip interior and further defining a window in communication with the core grip interior;
wherein the core grip is housed within the outer body interior.

2. The conductor splice connector of claim 1, further comprising a transition block inserted through the window, the transition block comprising a first outer channel and a second outer channel.

3. The conductor splice connector of claim 2, wherein the first and second outer channels are disposed on opposing sides of the transition block.

4. The conductor splice connector of claim 2, wherein the first and second outer channels each extend between a first end disposed within the core grip interior and a second end disposed exterior to the core grip interior.

5. The conductor splice connector of claim 1, further comprising a first routing clamp and a second routing clamp, each of the first and second routing clamps disposed on the core grip such that the window is positioned between the first and second routing clamps.

6. The conductor splice connector of claim 5, wherein each of the first and second routing clamps comprises a perimeter channel defined in an exterior surface of each of the first and second routing clamps.

7. The conductor splice connector of claim 6, wherein each of the first and second routing clamps further comprises a transition channel defined in the exterior surface of the first and second routing clamps, the transition channel in communication with the perimeter channel.

8. The conductor splice connector of claim 1, wherein the outer body is formed from aluminum.

9. The conductor splice connector of claim 1, wherein the core grip is formed from a steel.

10. A conductor splice connector, comprising:
an outer body defining an outer body interior;
a first collet assembly, the first collet assembly comprising a collet and a collet housing;
a second collet assembly, the second collect assembly comprising a collet and a collet housing; and
a transition connector, wherein the transition connector connects the first collet assembly and second collet assembly, and
wherein the first collet assembly, the second collet assembly, and the transition connector are housed within the outer body interior.

11. The conductor splice connector of claim 10, wherein the collet housings of the first and second collet assemblies each include a threaded portion.

12. The conductor splice connector of claim 11, wherein the transition connector includes a first mating threading portion threadably connectable to the threaded portion of the first collect assembly, and wherein the transition connector includes a second mating threading portion threadably connectable to the threaded portion of the second collect assembly.

13. The conductor splice connector of claim 10, wherein the transition connector defines a transition connector interior.

14. The conductor splice connector of claim 10, wherein the transition connector comprises a nut.

15. The conductor splice connector of claim 10, wherein the outer body is formed from aluminum.

16. The conductor splice connector of claim 10, wherein the first collet assembly, the second collet assembly, and the transition connector are each formed from a steel.

17. A conductor splice connector, comprising:
an outer body defining an outer body interior; and
means for conductor splicing and optical fiber splicing housed within the outer body interior.

18. The conductor splice connector of claim 17, wherein the outer body is formed from aluminum.

19. The conductor splice connector of claim 17, wherein the means for conductor splicing and optical fiber splicing comprises a core grip.

20. The conductor splice connector of claim 17, wherein the means for conductor splicing and optical fiber splicing comprises first and second collect assemblies.
